(19) United States
(12) Patent Application Publication
(10) Pub. No.: US 2007/0224313 A1
(43) Pub. Date: Sep. 27, 2007

(54) Sugarfree Wine

(76) Inventors: Douglas Stauffer, Broomfield, CO (US); Thomas Bueb, Westminster, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/690,593

(22) Filed: Mar. 23, 2007

Related U.S. Application Data
(60) Provisional application No. 60/743,707, filed on Mar. 23, 2006.

(51) Int. Cl. C12G 1/00

(52) U.S. Cl. 426/15

(57) ABSTRACT

The present invention provides a sugarless red or white wine with palatable sweetness derived from xylitol added to a concentration from about 1 to about 15 grams per gallon after the completion of the fermentation process. Optionally the wine also contains less than 10 ppm sulfites, but has not been subjected to any ion exchange treatments.

### CROSS-REFERENCE TO RELATED APPLICATIONS

This application claims benefit of U.S. Provisional Application 60/743,707 filed Mar. 23, 2006, which application is incorporated by reference to the extent there is no inconsistency with the present disclosure.

### REFERENCE TO SEQUENCE LISTING, A TABLE, OR A COMPUTER PROGRAM LISTING COMPACT DISK APPENDIX

Not applicable

### STATEMENT REGARDING FEDERALLY SPONSORED RESEARCH OR DEVELOPMENT

Not applicable

### BACKGROUND OF THE INVENTION

The field of this invention is winemaking, especially to produce wine without additional sugar or grape juice added after fermentation, but pleasantly sweet, and optionally without added sulfites.

There is a growing awareness of carbohydrate consumption and a trend for providing sugar free products with the taste of conventional sweetening for those who, by choice or through need, avoid sugars. The present invention provides wines sweetened to the desired taste with xylitol rather than sucrose or grape juice.

Many consumers today elect to limit their intake of carbohydrates in order to lose or maintain their weight. Others must limit carbohydrate intake due to Type I or Type II diabetes. For those individuals, the consumption of carbohydrates that affect blood glucose levels is especially critical.

Xylitol is a five carbon sugar alcohol (C₅H₁₂O₅) that does not significantly affect blood sugar levels in the human body. It has the same taste and sweetness as conventional sugar (sucrose), but it is not metabolized by the human body. In addition, it is known to inhibit caries-causing streptococci and certain pathogenic streptococcal bacterial. It has been widely used as a sweetener in chewing gums, candies and certain beverages.

Duitschaever et al. 91984) Am. J. Enol. Vitic. 35:88-93 reported elducoration of white wine with xylitol; the amounts added were from 5 to 27 g/L (or about 20 to 108 grams per gallon). The wines sweetened with xylitol were found acceptable at the evaluated levels of sweetener.

In addition, there are those who choose or need to avoid or limit sulfite intake. All grape wines contain some sulfites, which may be derived from sulfur used in the vineyard or which may have been added during picking to prevent spoilage. For the wine industry, grapes are often treated with sulfites before and/or after crushing to inhibit undesirable microorganisms and to serve as an antioxidant. After fermentation, sulfites may be added to limit secondary fermentation, to prevent oxidation and the development of off flavors. Sogg reported (Wine Spectator, Nov. 15, 2002) reported that wine often contains 25-40 mg/L sulfites when bottled. All wines containing higher than 10 mg/L must carry a warning that sulfites are present, as mandated by the United States Food and Drug Administration. However, after the completion of wine-making, the sulfites do not provide further benefit. Due to individuals with allergies or sensitivities to ingested sulfite, those additives can be problematic.

U.S. Pat. No. 5,071,664 (Brown, 1991) teaches a method for removing sulfites from wine by treating a standard wine with a strong base ion exchange resin, then a strong acid ion exchange resin and finally with carbon to yield a wine containing less than 10 ppm sulfite. Color and flavor are affected by this treatment.

There is a need in the art for wines without sugar which affects blood sugar levels in humans and such wines which are also sulfite-free.

### BRIEF SUMMARY OF THE INVENTION

The present invention provides sugar free wines which are of a palatable sweetness due to the addition of about 1 to about 15, or 1 to 10, grams xylitol per gallon, after the grape juice has been fermented to dryness. The wine can be produced by the fermentation of grape juice from crushed grapes using wine yeast, especially Saccharomyces cerevisiae, as well as juice from crushed fruits including but not limited to, apples, oranges, tangerines, berries, peaches, pears, elderberries, cherries, or fruit mixtures.

A surprising advantage associated with the addition of xylitol is that microorganisms responsible for secondary fermentation or spoilage that can cause off flavors in the wine are inhibited by the xylitol, resulting in the reduction or prevention of undesirable flavors.

### DETAILED DESCRIPTION OF THE INVENTION

White table wines and/or low-alcohol wines are often made more pleasing to the palate by improving the balance of the acidity and astringency by commonly adding sucrose or natural grape (or other fruit) juice after fermentation.

As used in the present application, sugar-free (or sugarless) means that the sugar concentration (metabolizable by humans) is less than about 0.1%. The relevant sugars are those natural six carbon sugars (and disaccharides) which impact the blood sugar in a human who has ingested the relevant sugar(s). Xylitol does not affect blood sugar in humans.

Xylitol is a sugar alcohol found in plants. It looks and tastes like sugar (sucrose) and it does not produce an unpleasant aftertaste. It has been used in cooking, baking and as a sweetener for beverages. Although it is metabolized by some microorganisms, it is not utilized by the yeasts and bacteria most likely to be present in wine.

Xylitol had been used as a sweetening agent in white wine (Duitschaever et. al., 1984, supra), but surprisingly, the present inventors found that significantly lower amounts of xylitol were sufficient to produce palatable red and white wines of appropriate sweetness. In a particular batch of red wine produced from grape crushate from the Grand Junction area of Colorado, 1.67 grams per gallon was used, and in a white wine produced from grapes from the same region, 3.33 grams per gallon xylitol gave the desired sweetness. In both cases, there was no residual sugar remaining after the fermentation. Xylitol can be used to sweeten rose or blush wines, too, still wines or effervescent wines, and also other wines made from fruits other than grapes or other materials containing sugars which wine yeasts can ferment to produce alcohol as well.

Because there are significant numbers of consumers who are allergic to or sensitive to sulfites, there is a demand for sulfite free wine. Typically sulfite is added in the form of potassium metabisulfate to protect the wine from oxidization and microbial spoilage during and after fermentation. In general, white wines have higher sulfite content than red wines. To be labeled sulfite-free, government regulations require that there must be less than 10 mg/L of sulfite in a wine. It is noted that nearly all wines contain some sulfite originating from natural or uncontrolled sources in or on the uncrushed grapes. In certain embodiments of the present invention, wines are made and bottled without the addition of sulfite at any step after the grapes are harvested. The xylitol added as a sweetener also serves to inhibit microorganisms in the wine that might otherwise produce metabolic products with unpleasant flavors or be responsible for affecting the color or aroma.

As used in the present application a wine that is “sulfite-free” means that the sulfite concentration is less than 10 mg per liter and no sulfites are added after the grapes have been harvested. The legal limit for sulfite in the United States is 350 ppm, but most California wines average 80 ppm, according to “What's in that Bottle of Wine You're Drinking?”, Beekman Wines & Liquors, printed on Mar. 8, 2006 from the internet site beekmanwine.com/prevtopbo.htm. Specifically excluded from the sulfite-free wines of the present invention are those that are produced by treating the wine with an ion exchange resin to remove sulfite; such treatment is likely to have an adverse effect on the flavor of the wine.

The red or white wine-making process is begun with harvested grapes of the desired variety or varietal mix. The grapes are crushed and destemmed. For red wines, the crushate is allowed to remain in contact with the skins so that the color is leached into the juice. Alternatively, the juice of a single variety or mixture or a mixture of juices may be used. The crushate may be held at cold temperatures, and then it is fermented after the addition of yeast. In the process of the present invention, commercially available strains of wine yeast are added in accordance with the supplier's instructions. The fermented crushate is pressed to separate the fermented mixture from the must (solid material including skins, seeds, flesh) before or after the initial fermentation, and fermentation is allowed to go to completion, from two to about six months so that all the starting sugar from the grapes has been fermented and none remains. If the starting material is especially high in sugar, the fermentation may stop when the alcohol level exceeds 14% (vol/vol). Desirably the alcohol content is less than 14% vol/vol. The wine may be cold-stabilized or fining agents may be used to clarify the wine. The pH is adjusted as necessary to between 3.0 and 3.6 with citric or tartaric acid. In some cases, ascorbic acid is added as an oxygen scavenger. The desired sweetness is achieved by the addition of dry (granular) xylitol, generally from about 2 to about 6 grams per gallon. In specifically exemplified embodiments, 3.33 g/L for white wine and 1.67 g/L for red wine are added. The wine may then be bottled immediately or after aging in barrels to impart desired flavor elements.

All references cited herein are hereby incorporated by reference to the extent there is no inconsistency with the present disclosure. The references cited herein are indicative of the level of skill in the relevant art(s).

Although the description herein contains certain specific examples and information, these should not be construed as limiting the scope of the invention but as merely providing illustrations of some of the presently preferred embodiments of the invention. For example, thus the scope of the invention should be determined by the appended claims and their equivalents, rather than by the examples given.

We claim:

1. A sugarless wine comprising xylitol at a concentration from 1 to 15 grams per gallon.

2. The sugarless wine of claim 1, wherein said wine comprises xylitol at a concentration from 1 to 10 grams per gallon.

3. The sugarless wine of claim 2, wherein said wine comprises less than 10 milligrams/liter sulfite.

4. The sugarless wine of claim 2, wherein said wine is red and comprises xylitol at a concentration from 1 to 5 grams per gallon.

5. The sugarless wine of claim 2, wherein said wine comprises xylitol at a concentration from 1.5 to 4 grams per gallon.

6. The sugarless wine of claim 2, wherein said wine is white and comprises xylitol at a concentration from 2 to 10 grams per gallon.

7. The sugarless wine of claim 6, wherein said wine comprises xylitol at a concentration from 5 to 7.5 grams per gallon.

8. A method of inhibiting development of undesirable flavors in wine, said method comprising the step of adding from 1 to 15 grams of xylitol per gallon of the wine after the primary fermentation.
